(19) United States
(12) Patent Application Publication
(10) Pub. No.: US 2026/0018769 A1
(43) Pub. Date: Jan. 15, 2026

(54) BATTERY ASSEMBLY AND METHOD

(71) Applicant: Flow-Rite Controls, Ltd., Byron Center, MI (US)

(72) Inventors: Dennis J. Anderson, Coopersville, MI (US); Mark W. Herrema, Rockford, MI (US)

(21) Appl. No.: 18/769,789

(22) Filed: Jul. 11, 2024

(51) Int. Cl. H01M 50/77; H01M 50/103; H01M 50/645; H01M 50/664

(52) U.S. Cl. CPC H01M 50/77; H01M 50/103; H01M 50/645; H01M 50/664

(57) ABSTRACT

A battery assembly for circulation of an electrolyte composition comprises a jar body having an upper and a lower end and a floor at the lower end, one or more sidewalls presenting an interior and an exterior surface, and a jar cover. The jar body defines an interior cavity disposed about a vertical axis. The battery assembly comprises two or more ports including a first port and a second port. The battery assembly also comprises one or more valve assemblies. The electrolyte composition is evacuated from the interior cavity through the first port or the second port and is replaced with additional electrolyte composition through the other port to create an electrolyte composition flow pattern within the interior cavity between the lower end and the upper end of the battery assembly.

### FIELD OF THE DISCLOSURE

The present disclosure relates generally to a battery assembly and a method of temperature control of the battery assembly during pickling, formation, and charging.

### BACKGROUND

Lead acid batteries are used in many applications including automobile applications and uninterruptible power supply systems. Lead acid batteries provide energy to start engines, and are maintenance free, and durable. Lead acid batteries are recyclable and thus environmentally friendly.

Lead acid batteries function via a chemical reaction between lead and sulfuric acid. During the discharge process, the lead and lead oxide plates in the battery react with the sulfuric acid electrolyte to produce lead sulfate and water. As the battery discharges, the concentration of sulfuric acid decreases, and the concentration of lead sulfate increases. This causes the voltage of the battery to decrease, and the battery eventually becomes unable to provide enough power. During the charge process, an external source of electrical energy is used to reverse the chemical reaction that occurs during discharge. This causes the lead sulfate to break down into lead and lead oxide, and the sulfuric acid concentration to increase. As the battery charges, the concentration of sulfuric acid increases, and the concentration of lead sulfate decreases. This causes the voltage of the battery to increase, and the battery becomes fully charged.

Lead acid batteries are manufactured using careful maintenance of equipment in an automated controlled environment in a time-consuming manufacturing process. The lead acid battery manufacturing process requires many steps including assembly, filling, forming, and final assembly.

The forming step, which includes pickling and charging, is critical and time consuming. The step of forming can take several hours to several days. The step of forming is sensitive to temperature and to the specific gravity of the sulfuric acid. The step of forming has been traditionally conducted with a “box formation” process. The box formation process involves filling batteries with low specific gravity acid and then charging for 40 to 80 hours according to a specific charging profile. The charging profile contains charging, discharging and resting steps. Temperature rises during the box formation process and a cooling system is used to keep the temperature of the battery in range to avoid damaging the battery. During the box formation process gasses including acid fume are released and ventilation is required.

The step of forming first involves allowing for the electrolyte to soak into the active material of the electrode plates, which is usually an exothermic process causing an interior temperature to become elevated. During the step of forming, the sulfuric acid electrolyte reacts with the lead and the lead paste to improve the energy storage and life of the battery. More specifically, cured pasted plate is converted into electrochemically active porous materials, i.e., lead-di-Oxide (PbO₂) and Lead (Pb) on the positive and negative plates, respectively.

The step of forming also involves attaching the lead acid battery to an electrical supply to charge. This part of the step of forming is endothermic and generates more acid, which causes subsequent exothermic reactions. So, although this part of the step of forming is endothermic, and absorbs heat, the resulting exothermic reactions generate an equivalent amount or even more heat than is absorbed, causing the interior temperature of the battery to remain elevated or even further increase. Excess heat may also occur as a result of power dissipation as current flows through the interior resistance of the battery during charging or discharging (also known as Joule heating).

Excessive heat generated can result in a number of issues, including: active chemicals may expand causing the electrochemical cells to swell, pressure may build up inside the electrochemical cells, increased swelling and pressure may cause mechanical distortion of components (such as outward deformation, e.g., bulging), mechanical distortion may result in short circuiting as components move away from one another and create leak paths or contact is lost, cracking of components may occur due to prolonged operation at excessively high temperatures, thermal runaway during chemical reactions, gasses are given off, and/or one or more cells may rupture or explode due to the increased temperatures.

To control the heat generated during formation and maintain an interior temperature of the lead acid battery at a threshold temperature, chilled electrolyte composition may be used for the step of filling to result in an overall lower interior temperature of the battery assembly after the exothermic reactions occur. In some processes, the lead acid battery is submerged within a temperature-controlled (e.g., chilled) water bath during formation to provide for heat removal. In other processes, heat exchangers are placed between the lead acid batteries and provide for heat removal. All the while, to control the specific gravity of the sulfuric acid, measurements are taken, and adjustments are made.

Considering the challenges above and the evolving strategies required to deal with the challenges, there remains a continued need for an improved battery assembly and method therefor that allows efficient interior cooling and quicker battery cell formation.

### SUMMARY

A battery assembly is disclosed. The battery assembly provides for circulation of an electrolyte composition. The battery assembly includes a jar body and a jar cover. The jar body has an upper end and a lower end. The jar body comprises a floor, one or more sidewalls presenting an exterior and an interior surface. The interior surface defines an interior cavity disposed about a vertical axis. The battery assembly includes two or more ports including a first port and a second port and one or more valve assemblies. The electrolyte composition is evacuated from the interior cavity through the first port or the second port and is replaced with additional electrolyte composition through the other port to create an electrolyte composition flow pattern between the lower end and the upper end of the jar body.

In one embodiment, the first port is defined by a first sidewall of the one or more sidewalls and proximal the lower end of the jar body. In some such embodiments, the first port may be defined by a recessed wall portion of the jar body such that a first end of a first fitting disposed in the first port does not break a plane defined by an exterior surface of the first sidewall.

In one embodiment, a first valve assembly is disposed at the second end of the first fitting. In some such embodiments, the first valve assembly can be a one-way valve.

In some embodiments, the one or more sidewalls include a first sidewall, a second sidewall, a third sidewall, and a fourth sidewall.

In one embodiment, the floor includes a plurality of bridge rests extending into the interior cavity for supporting a plurality of battery plates. In some such embodiments, the plurality of bridge rests create a gap between an upper surface of the floor and the plurality of battery plates.

In some embodiments, a second end of a first fitting, a second end of a first valve assembly, and/or a hose extending from the second end of the first fitting, or the first valve assembly extends into the gap created by the plurality of bridge rests.

In one embodiment, the second port is defined by the jar cover and is shaped to receive: a second valve assembly for filling the interior cavity with the electrolyte composition; and a first connector for evacuation of the electrolyte composition during formation. In some embodiments, the jar cover also defines a positive port and a negative port for receiving terminal fittings.

In some embodiments, the first port is for replacing evacuated electrolyte composition and is defined by the one or more sidewalls proximal the lower end of the jar body and the second port is for evacuating the electrolyte composition and is defined by the jar cover proximal the upper end of the jar body. As such, when the electrolyte composition is evacuated and replaced with additional electrolyte composition the electrolyte composition flow pattern is created with the electrolyte composition flowing from the lower end of the jar body to the upper end of the jar body in upward direction along the vertical axis.

In one embodiment, at least one of the one or more valve assemblies is adapted to pull a vacuum, inject the electrolyte composition or additional fluids into the interior cavity, remove the electrolyte composition or additional fluids from the interior cavity, vent the interior cavity, or any combination thereof.

In some embodiments, at least one of the two or more ports, e.g. the first port, are shaped to receive a plug.

A method of making a battery assembly comprising a jar body defining an interior cavity disposed about a vertical axis and having an upper end and a lower end, the jar body including a floor, one or more sidewalls, and a recessed wall portion defining a first port adjacent the lower end is also disclosed. The method includes the steps of:
providing a mold defining a mold cavity;
injecting a thermoplastic composition into the mold; and
ejecting the jar body from the mold with a stripper plate;
   wherein the first port prevents formation of a vacuum between the jar body and the mold to prevent deformation of the jar body during the step of ejecting.

In one embodiment, the method further comprises the step of molding a jar cover shaped for attachment to the upper end of the battery jar, the jar cover comprising a second port, a positive terminal port, and a negative terminal port, wherein the first and second ports can be used to evacuate and replace electrolyte composition to create an electrolyte composition flow pattern to expedite formation of a battery cell.

A method of forming a battery including a battery assembly having an upper and a lower end and comprising a battery jar and a jar cover is disclosed. The battery jar defines an interior cavity disposed about a vertical axis and two or more ports. The method comprising the steps of:
filling the interior cavity with an electrolyte composition;
forming the battery assembly;
evacuating the electrolyte composition from the interior cavity;
replacing of the electrolyte composition evacuated from the interior cavity; and
forming an electrolyte composition flow pattern within the interior cavity between a first two or more ports and a second of the two or more ports.
   The steps of evacuating and replacing are conducted to control an interior temperature of the electrolyte composition within the interior cavity.

In one embodiment, the step of filling is conducted under a vacuum and the vacuum is pulled before and/or simultaneous with the step of filling.

In one embodiment, the electrolyte composition introduced during filling is chilled to a temperature of from about 0 to about 20° C.

In many embodiments, the steps of evacuating and replacing are conducted simultaneously with the step of formation.

In some embodiments, the interior cavity has a fill capacity and the steps of evacuating and replacing of the electrolyte composition are conducted with a volume of the electrolyte composition that is greater than the fill capacity.

In one embodiment, the steps of evacuating and replacing further include at least partial replacement of the electrolyte composition. In some such embodiments, the steps of evacuating and replacing includes removal of a first electrolyte composition and replacement with a second electrolyte composition. In one such embodiment, the first electrolyte composition can have a lower specific gravity than the second electrolyte composition.

In one embodiment, a first of the one or more ports is located proximal the lower end of the battery assembly and the step of replacing occurs through a first fitting including a first valve seated in the first ports, and a second of the one or more ports is located proximal the upper end of the battery assembly. In this embodiment, the step of evacuating occurs through the second port. As such, the steps of evacuating and replacing create an electrolyte composition flow pattern within the interior cavity with the electrolyte composition moving from the lower end of battery jar to the upper end of the battery jar in upward direction along the vertical axis.

In one embodiment, the method includes the step of seating a plug in the first port subsequent to the step of formation.

Of course, many embodiments of the method involve forming one or more battery cells simultaneously.

These and other features of the disclosure will be more fully understood and appreciated by reference to the description of the examples and the drawings.

Before the examples of the disclosure are explained in detail, it is to be understood that the disclosure is not limited to the details of operation or to the details of construction and the arrangement of the components set forth in the following description or illustrated in the drawings. The disclosure may be implemented in various other examples and of being practiced or being conducted in alternative ways not expressly disclosed herein. In addition, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various examples. Unless otherwise expressly stated, the use of enumeration should not be construed as limiting the disclosure to any specific order or number of components. Nor should the use of enumeration be construed as excluding from the scope of the disclosure any additional steps or components that might be combined with or into the enumerated steps or components.

### BRIEF DESCRIPTION OF THE DRAWINGS

FIG. 1 is a perspective view of an embodiment of a battery assembly in accordance with the subject disclosure.

FIG. 2 is a cross-sectional view of the battery assembly of FIG. 1 at 2-2 providing a perspective view of an interior cavity defined by a jar body comprising a floor and 4 sidewalls, and a jar cover.

FIG. 3 is an enlarged cross-sectional view of an upper end of the battery assembly of FIG. 1 at 3 showing a second port having a second valve assembly disposed therein, a positive port, and a negative port.

FIG. 4 is an exploded view of the battery assembly of FIG. 1.

FIG. 5 is an exploded view of an embodiment of a valve assembly of the battery assembly of FIG. 1.

FIG. 5A is a cross-sectional view of the second valve assembly of FIG. 5 in the open position.

FIG. 5B is a cross-sectional view of the second valve assembly of FIG. 5 in the closed position.

FIG. 6 is an enlarged view of a jar cover of the battery assembly of FIG. 1.

FIG. 7 is a first embodiment of a positive fitting included in the battery assembly of FIG. 1.

FIG. 8 is a second embodiment of a negative fitting included in the battery assembly of FIG. 1.

FIG. 9 is an enlarged cross-sectional view of a lower end of the battery assembly of FIG. 1 providing a perspective view of a port defined by a first sidewall of the battery assembly of FIG. 1.

FIG. 10 is an exploded perspective view an embodiment of a fitting and a plug seated in the first port defined by the first sidewall of the battery assembly of FIG. 1.

FIG. 11 is another exploded perspective view an embodiment of a first fitting and a plug seated in the first port defined by the first sidewall of the battery jar of FIG. 1.

FIG. 12 is a top view of the battery assembly of FIG. 1.

FIG. 13 is a cross-sectional top view of the battery assembly of FIG. 1 at 13-13.

FIG. 14 is a perspective view of the battery assembly of FIG. 1 showing a first hose in fluid communication with a first valve in a first port for supplying an electrolyte composition to an interior cavity of the battery assembly, a second hose in fluid communication with a second valve assembly in a second port for evacuating the electrolyte composition from the interior cavity of the battery assembly, a positive power line in electric communication with a positive port, and a negative power line in electric communication with a negative port.

FIG. 15 is a cross-sectional view of the battery assembly of FIG. 14 at 15-15.

FIG. 16 is cross-sectional view of the battery assembly of FIG. 14 illustrating the second valve assembly filling an interior cavity of the battery assembly with an electrolyte composition.

FIG. 17 is a side view of the battery assembly of FIG. 14 with the arrow illustrating an electrolyte composition flow pattern within the interior cavity with the electrolyte composition moving from the lower end of battery assembly to the upper end of the battery assembly in upward direction along the vertical axis.

FIG. 18 is an enlarged, cross-sectional side view of a first fitting, a first valve assembly, and a first hose seated in the first port defined by a recessed wall portion at the lower end of the battery assembly of FIG. 14.

FIG. 18A is an isolated side view of the first fitting, first valve assembly, and first hose of FIG. 18.

FIG. 18B is an exploded, cross-sectional view of the first fitting, first valve assembly, and the first hose of FIG. 18.

FIG. 19 is a cross-sectional side view of the second port defined by the second collar of the jar cover of the battery assembly at the upper end of the battery assembly of FIG. 17.

FIG. 20 is cross-sectional view of a battery cell comprising the battery assembly of FIG. 1 having a plug disposed in the first port.

FIG. 21 is a flow chart describing an embodiment of method of making a battery assembly comprising a jar body.

FIG. 22 is a flow chart describing an embodiment of a method of forming a battery including a battery assembly including a battery jar and a jar cover.

FIG. 23 is a perspective view of a battery including a plurality of battery cells, each battery cell comprising a battery assembly including a battery jar and a jar cover.

FIG. 24 is a top view of the battery of FIG. 23 including a plurality of battery cells in fluid communication with a fluid source and electronic communication with a power source.

FIG. 25 is a cross-sectional view of the battery of FIG. 23 at 25-25 including a plurality of battery cells in fluid communication with a fluid source and electronic communication with a power source.

### DETAILED DESCRIPTION

A battery assembly for circulation of an electrolyte composition is provided. The battery assembly provides temperature control during the battery manufacturing process, in particular, during the step of formation when making a lead-acid battery. The lead acid battery manufacturing process can include many steps including assembly, filling, forming (including pickling and applying current), and final assembly. The forming step, which includes pickling and charging, is critical and time consuming. The battery assembly allows for temperature control during formation thereby reducing forming time and increasing battery quality. The battery assembly can be a flooded lead acid battery assembly or a sealed lead acid battery assembly. The battery assembly can be used for lead-gel batteries, lead-fleece batteries, and pure lead batteries (the differences are mainly due to the material used as electrolyte). Lead acid batteries are used in many applications including automobile applications and uninterruptible power supply systems. While discussed below in connection with a lead acid battery, the present battery assembly and method is suitable for a wide range of applications, inside and outside of lead acid batteries. Referring to the Figures, wherein like numerals indicate corresponding parts throughout the several views, the battery assembly is illustrated and generally designated at 10.

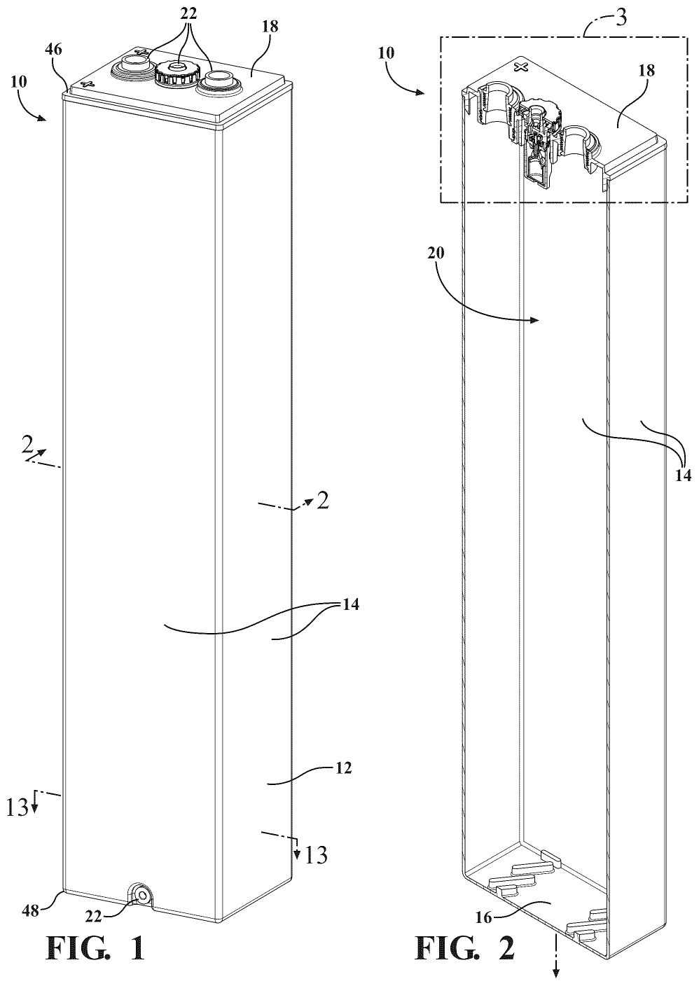

The battery assembly 10 comprises (1) a jar body 12 comprises a floor 16 and one or more sidewalls 14 presenting an interior and an exterior surface, and (2) a jar cover 18. An embodiment of the battery assembly 10 is illustrated in FIGS. 1 and 2. A perspective view of an embodiment of the battery assembly 10 for circulation of an electrolyte composition illustrated in FIG. 1. FIG. 2 is a cross-sectional view of the battery assembly of FIG. 1 at 2-2 providing a perspective view of an interior cavity defined by the jar body 12 comprising the floor 16 and four sidewalls 14, and the jar cover 18.

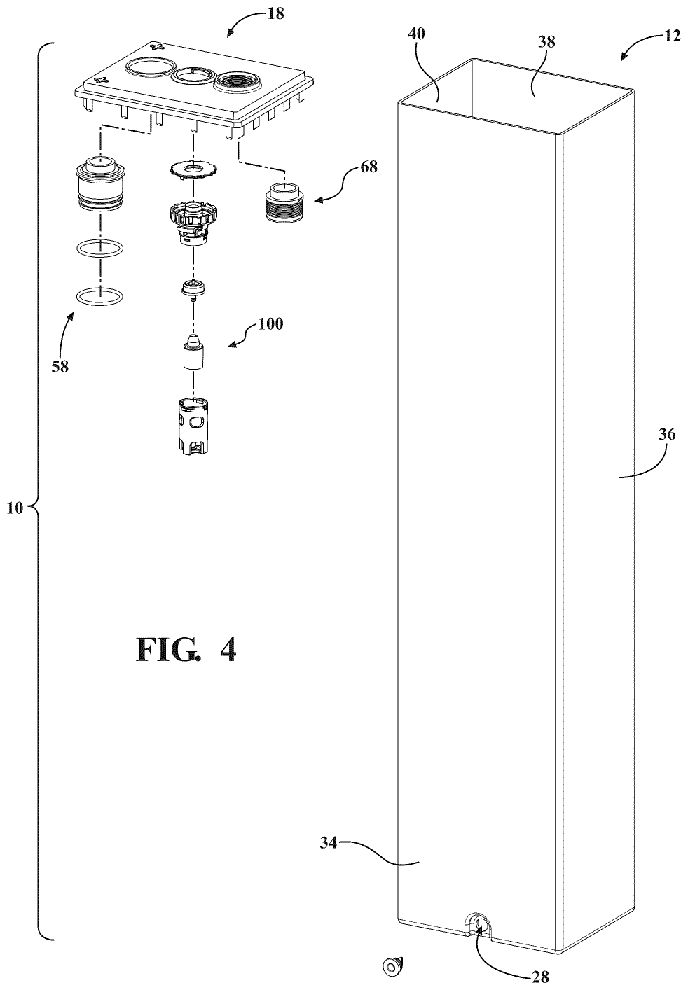

FIG. 4 is an exploded view of the embodiment of the battery assembly 10 of FIG. 1. FIG. 4 illustrates various components of the battery assembly 10 which are discussed in detail below. With continued reference to FIGS. 1-4 and the embodiment illustrated, the jar body 12 includes the four sidewalls. As is illustrated in the cross-sectional view of the battery assembly 10 in FIG. 2, an interior cavity 20 is defined by the jar body 12 and disposed about a vertical axis Av. Although not illustrated, the interior cavity 20 of the battery assembly 10 typically includes a bridge supporting at least two lead plates having an acid-resistant outer skin that are used as electrodes. The electrolyte composition typically comprises sulfuric acid and water. The battery assembly 10 has an upper end 46 and a lower end 48. The battery assembly 10 also includes two or more ports 22 and one or more valve assemblies 24.

In one embodiment, the battery assembly 10 includes a first port 28 and a second port 26. In some such embodiments, the first port 28 is defined by one of the one or more sides walls of the jar body 12 and has a first fitting 70 including a first valve assembly 90, typically a one-way valve disposed therein, and the second port 26 is defined by the jar cover 18 and has a second coupling and/or a second valve assembly 100 seated therein.

The battery assembly 10 typically comprises the jar body 12 including the floor 16 and the one or more sidewalls 14 presenting an interior and an exterior surface. The jar body 12 (and the jar cover 18 for that matter) typically comprise a polymer composition, e.g. a plastic, which can be molded to shape. The jar body 12 houses the components of the battery. In various embodiments, the jar body 12 includes: one sidewall, e.g. having a circular or ovular profile; two sidewalls, e.g. having a football-like profile; three sidewalls, e.g. having a triangular profile; have four sidewalls, e.g. having a rectangular or square profile; or could have even more than four sidewalls. In the embodiment illustrated, the one or more sidewalls 14 include a first sidewall 34, a second sidewall 36, a third sidewall 38, and a fourth sidewall 40.

The jar body 12 typically also includes the floor 16. The floor 16, which is located at the lower end 48, presents an upper and a lower surface. In some embodiments, the floor 16 includes a plurality of bridge rests 76 extending into the interior cavity 20, which can support a bridge (not illustrated) having a plurality of battery plates (not illustrated) and separators that are used to keep the positive and negative battery plates from touching each other, which could cause a short circuit.

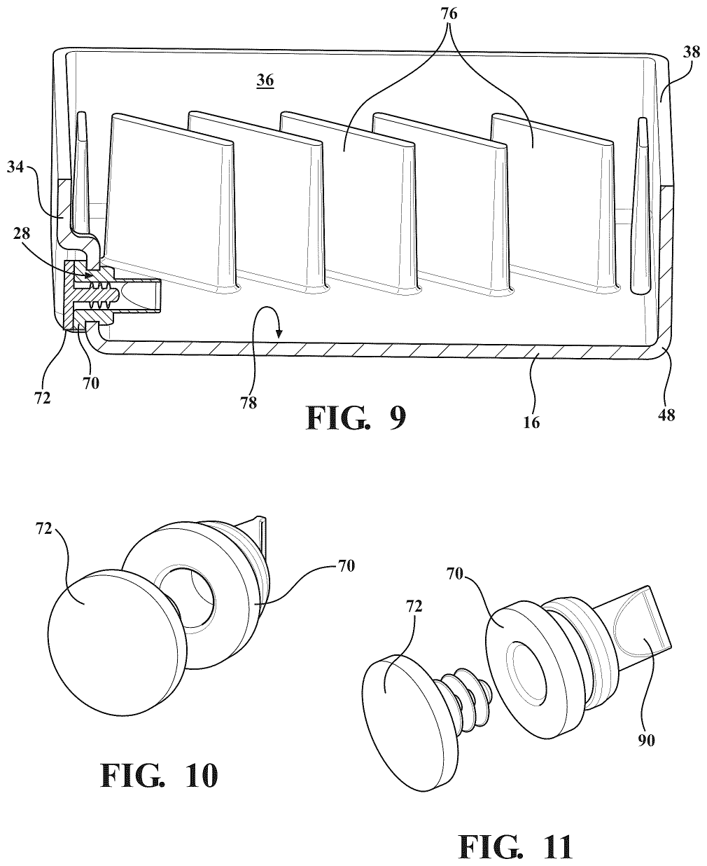

In many embodiments, the plurality of bridge rests 76 create a gap between an upper surface of the floor 16 and a plurality of battery plates. FIG. 9 is an enlarged cross-sectional view of the lower end 48 of the battery assembly 10 of FIG. 1 providing a perspective view of the floor 16 illustrating the plurality of bridge rests 76 extending from the upper surface 78 into the interior cavity 20 and the gap (as well as the first port 28 defined by a first sidewall 34). FIG. 13 is a top cross-sectional view of the battery assembly 10 of FIG. 1 at 13-13, which shows a location of the plurality of bridge rests 76 on the floor 16. Although the plurality of bridge rests 76 illustrated are arranged in a specific pattern it should be appreciated that the height, length, and orientation of the plurality of bridge rests 76 on the floor 16 can be changed to achieve various desired flow patterns within the interior cavity 20. For example, the plurality of bridge rests 76 can have a height of 0.5, 0.875, or 1.25 inches and have various orientations on the floor 16 of the jar body 12.

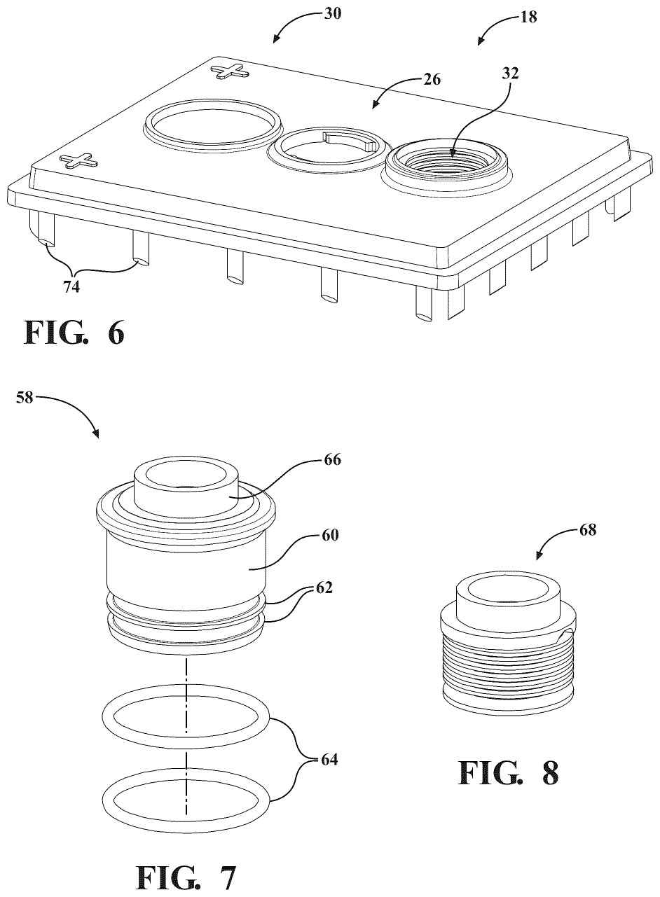

As is illustrated in FIG. 1-6, the battery assembly 10 includes the jar cover 18. FIG. 6 is an enlarged view of the jar cover 18 of the battery assembly 10 of FIG. 1. The jar cover 18 includes a plurality of fastening elements 74 that cooperate with a plurality of corresponding fastening elements on the one or more sidewalls 14 of the jar body 12 (including the one or more sidewalls 14 and floor 16) to secure the jar cover 18 in place at the upper end 46 of the battery assembly 10. The jar cover 18 and/or the jar body 12 may include a sealing element such as a sealing channel and a sealing ring to fluidically seal the interior cavity 20 from an exterior of the battery assembly 10 when the jar cover 18 is connected to the jar body 12. Of course, the battery assembly 10 does not have to include the sealing element as a fluidic seal can also be provided by robust mechanical attachment of the jar cover 18 to the jar body 12.

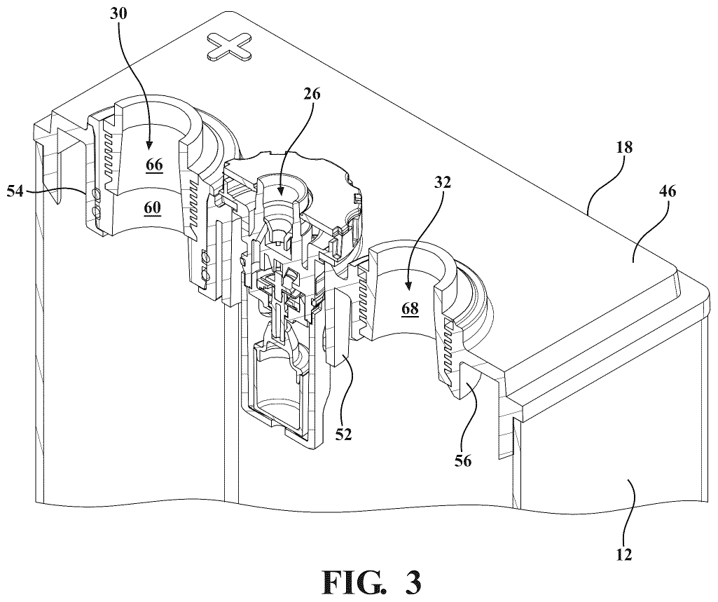

In the embodiment illustrated in the Figures, the jar cover 18 includes three of the two or more ports 22 of the battery assembly 10. More specifically, the jar cover 18 includes the second port 26, a positive port 30. The three ports extend through the jar cover 18. The three ports typically share a common centerline, and are typically arranged in groups of three. Other configurations of the three ports are possible, and the battery assembly 10 disclosed can be readily adapted to accommodate such variations. As is illustrated in FIG. 3, which is an enlarged cross-sectional view of an upper end 46 of the battery assembly 10 of FIG. 1 at 3 providing a perspective view of the three ports defined by the jar cover 18, the ports can have a fitting seated therein to facilitate connection of a valve assembly, a terminal fitting, or other functional part. The three ports can have a bayonet type fitting, e.g. a ¼ turn fitting disposed therein.

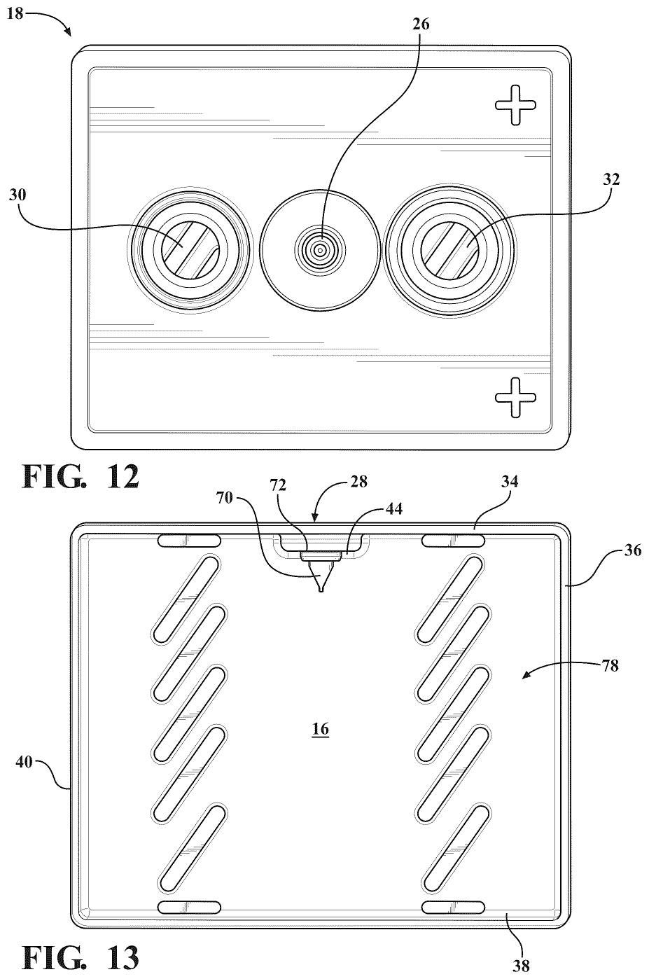

Referring now to FIG. 3, which is an enlarged cross-sectional view of an upper end 46 of the battery assembly 10 of FIGS. 1 at 3, the three ports are referred to herein as a second port 26, a positive port 30, and a negative port 32. The second, positive, and negative ports 26, 30, 32 are defined by a first, a positive, and a negative collar 52, 54, 56 of the jar cover 18. FIG. 12 is a top view of the battery assembly 10 showing the jar cover 18 of this embodiment including the second port 26, the positive port 30, and the negative port 32, with the second port 26 having a second valve assembly 100 seated therein and the positive and negative ports 30, 32 having exemplary, non-limiting fittings seated within. The second port 26 can be shaped to receive a vent cap such as the vent cap disclosed in U.S. Pat. No. 8,679,663 to Campeau, which is incorporated herein by reference in its entity. The positive and negative ports 30, 32 house positive and negative terminals, which provide electrical current (power).

The battery assembly 10 includes the first port 28, which is centrally located on the jar cover 18 and the second port 26, which is located on the first sidewall 34 in the embodiment illustrated. The electrolyte composition is evacuated from the interior cavity 20 through the second port 26 or the first port 28 and is replaced with additional electrolyte composition through the other port. As such, a flow pattern of the electrolyte composition between the first and second ports 26, 28 is formed within the interior cavity 20. The battery assembly 10 utilizes ports located on the jar body 12 that are proximal to the lower end 48 and ports that are proximal to the upper end 46 to create electrolyte composition currents and electrolyte composition flow patterns in the interior cavity 20 to efficiently cool the battery during the step of formation. For example, higher temperature electrolyte composition can be evacuated proximal the upper end 46, e.g., through a port in the jar cover 18, and cooler temperature electrolyte composition can be introduced proximal the lower end 48 to replace the electrolyte composition evacuated, this sequence of evacuating and replacing can create an electrolyte composition flow pattern within the interior cavity 20 between a first two or more ports and a second of the two or more ports within the interior cavity 20 in an upward direction along the vertical axis Av. In some embodiments, ports including valve assemblies are located perpendicular to the vertical axis Av to also create cross flow of the electrolyte composition within the interior cavity 20.

Although the embodiment illustrated utilizes a single port (the first port 28) located on the first sidewall 34 at the lower end of the battery assembly. The one or more sidewalls can included additional ports, which can be used to introduce the electrolyte composition and optionally one or more additional fluids into the interior cavity 20, remove the electrolyte composition and optionally one or more additional fluids from the interior cavity 20, and pull a vacuum or pressurize the interior cavity 20. Once the battery assembly 10 is formed the port(s) defined by the one or more sidewalls 14 can be plugged.

In some embodiments, the one or more sidewalls can included additional ports at the lower end of the battery assembly. The location of the port or ports on the sidewalls at the lower end of the battery assembly can be used to create flow patterns. In some embodiments, the third sidewall 38 includes an additional port with an additional valve disposed therein, wherein a first end of the additional valve does not break a plane defined by an exterior surface of the third sidewall 38. In some such embodiments, the additional port is defined by a recessed wall portion. Further, in some such embodiments, the first and the additional ports are opposite one another and can be used to create crossflow of the electrolyte composition within the interior cavity 20. In a typical embodiment, the electrolyte composition is evacuated from the first port (in the jar cover) and additional electrolyte composition is injected into the one or more ports located on the one or more sidewalls at the lower end of the battery assembly, evacuation of the electrolyte composition at the top of the battery assembly and injection of replacement electrolyte composition coupled with different configurations of 76 to create electrolyte flow patterns within the interior cavity 20 between the port(s) on the lower end of the battery assembly and the second port on the upper end of the battery assembly, which provides excellent temperature control and efficient battery formation.

In the embodiments described above, the electrolyte composition is removed from the interior cavity 20 through the second port 26 (defined by the jar cover 18) and replaced through the first port 28 (defined by the first sidewall 34). Of course, the battery assembly 10 can also be used to create flow of the electrolyte composition in a downward direction towards the lower end 48 of the jar body 12. In some such embodiments, the electrolyte composition is removed from the interior cavity 20 through the first port 28 (defined by the first sidewall 34) and replaced or injected through the second port 26 (defined by the jar cover 18).

The battery assembly 10 includes two terminals, a positive and a negative terminal, each serving a crucial role in during use or operation of the battery assembly during and after formation (an example of a lead acid battery is illustrated at 200 in the Figures of the subject application). The positive and negative terminals (also called posts or electrodes) on the battery assembly are formed in the positive and negative ports 30, 32, respectively.

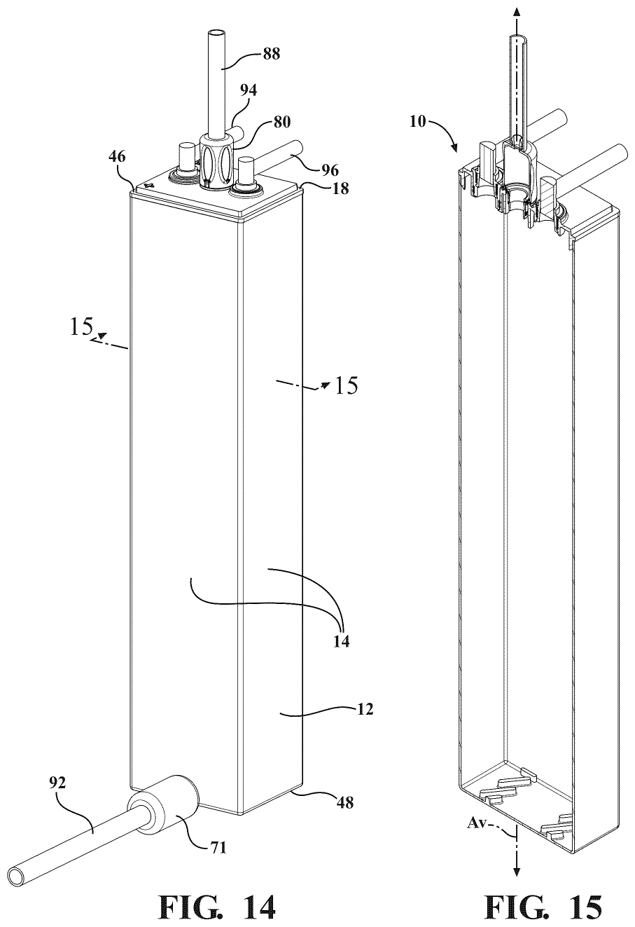

The positive terminal is typically designated with the color red and denoted with a “+” indicia. In a typical embodiment, the positive terminal comprises lead dioxide (PbO₂). Referring now to FIGS. 3 and 7, a positive electrical fitting 58 is disclosed that mechanically connects to the positive port 30. A close-up view of the positive electrical fitting 58 (sometimes referred to as a positive lead post) in the positive port 30 in the jar cover 18 in FIG. 3 is illustrated in FIG. 8. As is illustrated, the positive electrical fitting 58 includes a body 60 defining an outside surface that mechanically connects (e.g. with a bayonet type fitting) with the jar cover 18 to secure or seat the positive electrical fitting 58 in the positive port 30. The outside surface of the body 60 defines two seal channels 62 and includes two elastomeric O-rings 64, which sit in the two seal channels 62 and cooperate with the positive collar 54 on the jar cover 18 (which defines the positive port 30) to create a fluidic seal. In a typical embodiment, the body 60 comprises a red thermoplastic composition. The upper portion of the body 60 includes an upper flange that presents a red aesthetic to indicate that the terminal is a positive terminal. The body 60 includes a threaded inner surface, which receives a positive electrical fitting 66 comprising lead and having a threaded outer surface which allows for a connection of a positive power line 94. The upper portion of the positive electrical fitting 66 includes a flange and a collar (or post). The positive port 30 is filled with lead before the battery assembly 10 is staged for formation. FIGS. 14 and 15 illustrate the positive power line 94 connected to the positive electrical fitting, which is in electronic communication with the interior cavity.

The negative terminal is typically designated with the color black or blue and denoted with a “-” indicia. In a typical embodiment, the positive terminal comprises pure lead (Pb). Referring now to FIGS. 3 and 8, a negative electrical fitting 68 is disclosed that mechanically connects to the negative port 32. A close-up view of the negative electrical fitting 68 in the negative port 32 in the jar cover 18 in FIG. 3 is illustrated in FIG. 8. FIG. 8 provides an exploded view of a negative lead post or a negative electrical fitting 68, which can be insert molded into the jar cover 18 when the jar cover 18 is formed/molded. The upper portion of the negative electrical fitting 68 includes a flange and a collar (or post). A close-up view of the negative electrical fitting 68 in the negative port 32 in the jar cover 18 in FIG. 3 is illustrated in FIG. 8. The negative port 32 is filled with lead before the battery assembly 10 is staged for formation. A negative power line 96 can be connected to the negative electrical fitting 68. FIGS. 14 and 15 illustrate the positive power line 94 connected to the positive electrical fitting, which is in electronic communication with the interior cavity.

The battery assembly 10 also includes one or more valve assemblies, which can be seated in the port or attached to a fluid line that is coupled to and in fluidic communication with the interior cavity 20. The one or more valve assemblies can be adapted to inject the electrolyte composition or additional fluids into the interior cavity 20, remove the electrolyte or additional fluids from the interior cavity 20, pull a vacuum, vent the interior cavity 20, prevent back flow, or any combination thereof. In some embodiments, the first valve assembly comprises a hose coupling on the first end wherein removal of the hose closes the first valve assembly to prevent loss of the electrolyte composition from the interior cavity 20.

In one embodiment, the battery includes the first port 28 with a first valve assembly 90 having a first and a second end and disposed therein. In one example, the first valve assembly 90 is a duck bill valve. However, it should be appreciated that the first valve assembly 90 is not limited to a duck bill valve and various other one-way valve designs know in the art can be employed. In the embodiment illustrated the first port 28 is defined by a recessed wall portion 44 and located in the first sidewall 34 proximal the lower end 48. The recessed wall portion 44 and the first port 28 are clearly illustrated in the cross-sectional view of FIG. 9.

The first port 28 has the first fitting 70 seated therein. The first fitting 70 has a first end and a second end. In this example, a first connector 71, having an interference fit, is connected to the first end of the first fitting 70 and the first valve assembly 90 is coupled to the second end of the first fitting 70. The second end of the first fitting 70 extends into the interior cavity 20, more specifically into a gap above the upper surface of the floor 16.

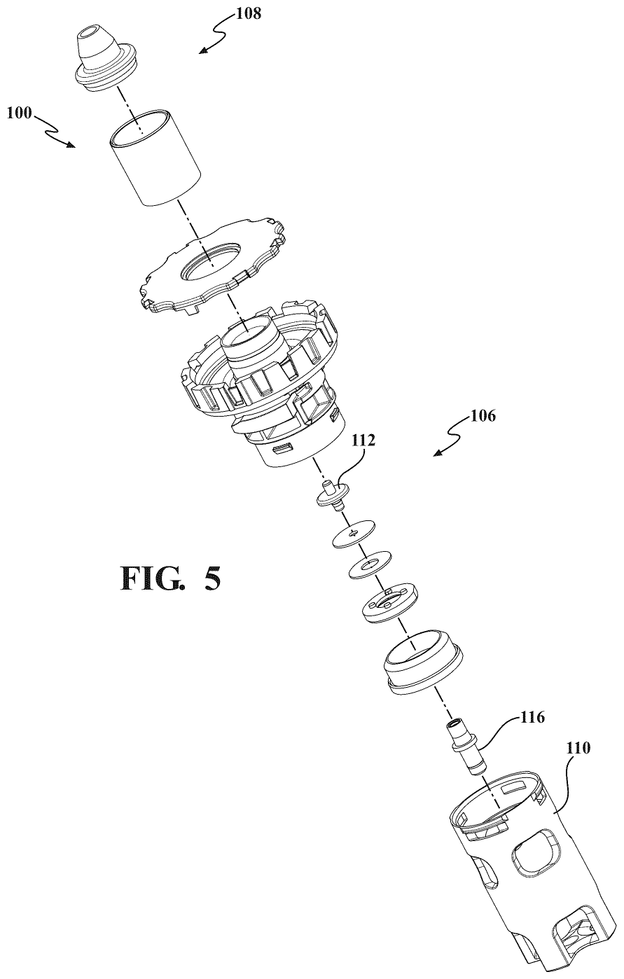

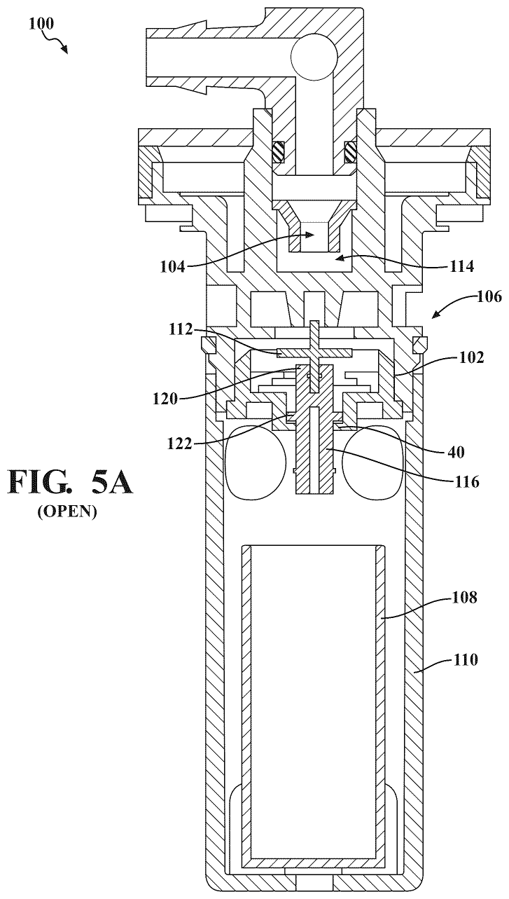

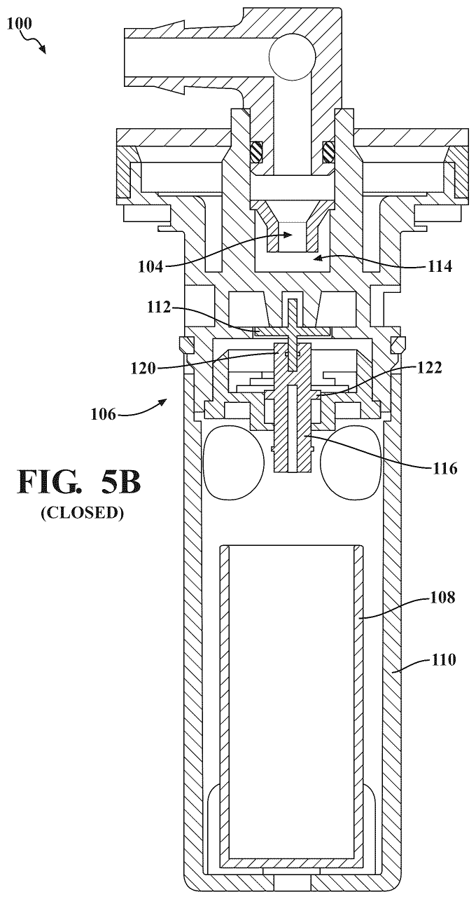

Some embodiments of the battery assembly 10 include a second valve assembly 100, which can be engaged in the second port 26 subsequent to the formation process. During formation, a fluid line is placed in fluidic communication with the second port 26 to allow for removal of the electrolyte. Once the formation process is complete, a one-way valve with venting, i.e. the second valve assembly 100, can be coupled to the second port 26 the first port once the battery cell is formed. The second valve assembly 100 allows for injection of liquid, e.g. water, into the battery to replace the liquid lost to evaporation and vented off during use of the battery. That is, exhaust gas is returned as water. Referring again to FIG. 3, the second port 26 an exemplary, non-limiting embodiment of the second valve assembly 100 is illustrated. The valve second valve assembly 100 is not present during filling and formation of the battery and is typically coupled to the second collar 52 to secure the second valve assembly 100 in the second port 26 after filling and formation. The embodiment of the second valve assembly 100 illustrated in the views of FIGS. 5, 5A, and 5B is particularly useful for re-filling and venting the interior cavity 20 of the battery assembly 10 once in use. The second valve assembly 100 can be actuated with a low energy level signal while operating effectively over a wide range of pressure and flow conditions. The second valve assembly 100 is not limited to the design illustrated. Examples of such assemblies are illustrated in U.S. Pat. No. 7,029,786 to Campau; U.S. Pat. No. 6,782,913 to Campau; U.S. Pat. No. 6,227,229 to Campau; U.S. Pat. No. 6,644,338 to Campau; and U.S. Pat. No. 8,802,258 to Campau et. al, all of which are incorporated herein by reference in their entirety.

As is illustrated in the exploded view of FIG. 5 and the cross-section views of FIGS. 5A and 5B the second valve assembly 100 includes a body 102, an inlet port 104, a displacer assembly 106, a displacer 108, a shroud 110, and an upper retainer 112. The body 102 mechanically connects with the second port 26 defined by the jar cover 18 to secure the second valve assembly 100 therein. The second valve assembly 100 allows for fill of the interior cavity 20 but prevents back flow.

FIG. 5A shows this embodiment of the second valve assembly 100 in an open position as occurs when the electrolyte composition level in the interior cavity 20 is below the displacer 108 reset position and before fluid is supplied to a second connector 80. Reset of the second valve assembly 100 from a closed position (FIG. 5B) to the open position occurs when the displacer assembly, including upper and lower valves 120 and 122, has dropped from its uppermost position. Having the upper valve rest on a lower member provides a stop. Some refill water from a previous cycle is trapped by having the end of the inlet port 104 extend below the upper rim of a water trap reservoir 114. This water trap blocks the gas path between a hose and the battery cell within the interior cavity 20.

The displacer 108 is directly connected to the stem 116 of a valve support assembly. When electrolyte level is low, the displacer 108 rests in its reset position, which opens both upper and lower valves 120 and 122. In this orientation, water is free to flow through both upper and lower valve ports. The forces on the valve support assembly are low so that the weight of the displacer 108 holds the second valve assembly 100 over the full range of operating pressures.

A feature of this valve design is that a relatively small displacer can be used compared to other float valves. This is because of the balanced valve design in which the force on the upper valve 120 acting to close the valve is reduced by the force on the lower valve 122 acting to keep the valve open. There is less net force required to hold the valve open, so the weight of the displacer 108 can be less than in other float valves.

The smaller displacer allows the use of a shroud 110 to protect the displacer 108. Other float valves use floats too large in diameter to allow the addition of a skirt. The valve would not fit through a bayonet style vent port, of the type widely used on industrial batteries. The shroud 110 surrounds the displacer 108 helping to shield it from floating debris. Portions of the shroud 110 extend down to at least the lowest level attained by the displacer when in the reset position.

As illustrated in FIG. 5B, when the electrolyte level rises sufficiently to lift the displacer 108, the upper and lower valves, 120 and 122, are pressed against their respective seats, by the pressure of the supply line, blocking further flow into the cell. The second valve assembly 100 is not designed to reopen once it has closed and supply pressure remains on. Reset to the ready position occurs only after supply pressure has been relieved. This pressure relief can be provided by a separate valve system on the water supply line, or the refill valves themselves can be designed to allow a small seepage that will slowly relieve line pressure after the water supply has been disconnected from the battery single-point watering system. In this way, the valves are reset into the ready state for the next watering cycle.

In some embodiments, the two or more ports 22 are shaped to receive a plug 72. The plug 72 can be permanent or temporary and can be received (inserted or seated) in the at least one of the two or more ports 22. In the embodiment illustrated, the second port 26 includes the first fitting 70, which is shaped to receive the plug 72. In the embodiment illustrated, the plug 72 has three seal rings (FIG. 11). FIG. 9 is an enlarged cross-sectional view of the lower end 48 of the battery assembly 10 of FIG. 1 providing perspective view of the first port 28 defined by the first sidewall 34, the first fitting 70 seated in the first port 28 and the plug 72 seated in the first fitting 70. FIGS. 10 and 11 show two different perspective views of the first fitting 70 and the plug 72.

As mentioned previously, the jar body 12 typically includes at least one port located proximal the lower end 48. In many embodiments, the electrolyte composition can be introduced through this port to replace the electrolyte composition evacuated from a port proximal the upper end 46. In the embodiment illustrated, the first port 28 is defined by a first of the one or more sidewalls 14 and proximal the lower end 48, i.e. the first sidewall 34. The recessed wall portion 44 is illustrated in the cross-sectional view of FIG. 9. The recessed wall portion 44 allows for the seating of the valve assembly or via the threading or various other connection means known in the art, wherein a first end of the valve assembly or a first end of the plug 72 does not break a plane defined by an exterior surface of the one or more sidewalls 14. In some embodiments, the second end of the first fitting 70 extends into the gap to better facilitate flow or circulation of the electrolyte composition via creation of the flow patterns in the interior cavity 20. In some embodiments, a hose or extension can be coupled to the first or the second port to allow for the replacement (or evacuation) in a more central location in the interior cavity 20 (i.e. closer to the vertical axis VA).

In various embodiments, hoses are connected to or in fluid communication with the two or more ports for pulling a vacuum, venting, and evacuating and replacing electrolyte composition within the interior cavity to control an interior temperature of the battery assembly 10. FIG. 14 is a perspective view of the battery assembly 10 of FIG. 1 having a first hose 92 fluid communication with the first valve assembly 90 to supply the replacement electrolyte composition, and a second hose 88 in fluid communication with the interior cavity.

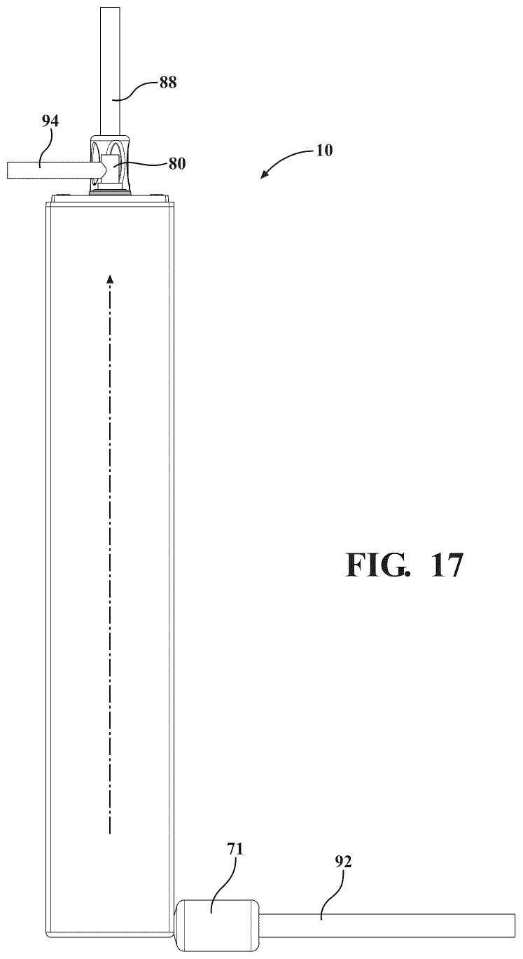

FIG. 15 is a cross-sectional view of the battery assembly of FIG. 14 at 15-15. In FIG. 15 the second port 26 is coupled to a second connector 80 and a second hose 88 for filling and evacuating the electrolyte composition and the first port 28 is connected to a first valve assembly 90 seated in the first fitting 70 having a second end that extends into the interior cavity 20. A first hose 92 is connected to the first valve assembly 90 to supply the replacement electrolyte composition. More specifically, the second end of the first fitting 70 extends into the gap above the upper surface of the floor 16. The first valve assembly 90 is configured to supply additional electrolyte composition to replace the electrolyte composition evacuated. As such, when the electrolyte composition is evacuated and replaced with additional electrolyte composition the electrolyte composition flows in an upward direction from the lower end 48 towards the upper end 46. FIG. 17 is a side view of the battery assembly 10 with the arrow illustrating a flow of electrolyte composition within the interior cavity 20 of the battery assembly 10. In many embodiments, once the step of formation is complete, the second connector 80 and/or the second hose 88 can be removed.

Still referring to FIG. 14, a positive power line 94 is in electrical communication with the positive port 30 and the negative power line 96 is in electrical communication with the negative port. These electrical pathways are required for the step of formation and ultimately assembly of a battery assembly.

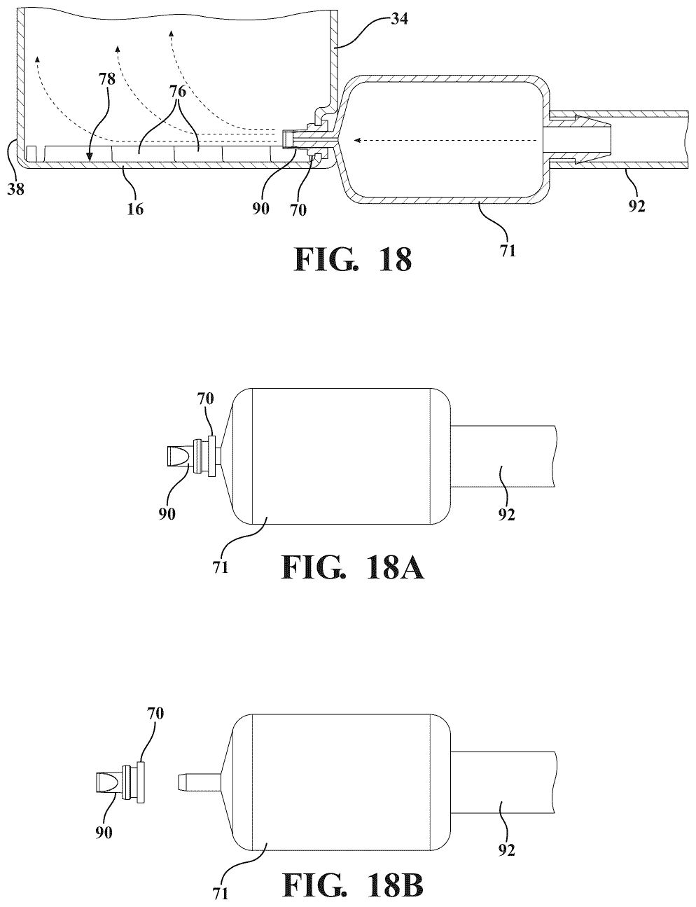

Referring now to FIGS. 18, 18A, and 18B, a first hose 92 is connected to the first valve assembly 90 to supply the replacement electrolyte composition. The first fitting 70, which is described above in FIGS. 9-11 has a first end that does not break a plane defined by the first sidewall 34 and has a second end that extends into the gap above the upper surface of the floor 16. In FIG. 18 a cross-sectional side view of the first fitting 70 coupled to the first valve assembly, coupled to a hose is illustrated. The recessed wall portion 44 is illustrated. In some embodiments, as is illustrated, the recessed wall portion 44 provides a cut out in the floor 19, this allows both direct and side access when connecting and removing the first valve assembly 90 and when inserting and removing the plug 72. With reference to FIGS. 1, 9, and 18, the recessed wall portion defines a recess. The recess is defined by a recessed floor and a wall. In other words, the recessed wall portion 44 comprises a recessed floor and a horseshoe shaped wall. The recessed floor is substantially parallel to the first sidewall. The wall is horseshoe shaped, with the cutout in the floor 16 opposite the curved portion of the horseshoe shaped wall. In the embodiment illustrated, the first port 28 is defined by the recessed floor of the first sidewall 34. The recessed wall portion 44 is illustrated in the cross-sectional view of FIG. 9. The recessed wall portion 44 allows for the seating of the valve assembly or via the threading or various other connection means known in the art, wherein a first end of the valve assembly or a first end of the plug 72 does not break a plane defined by an exterior surface of the one or more sidewalls 14. In this embodiment, the second end of the first fitting 70 extends into the gap to better facilitate flow or circulation of the electrolyte composition via creation of the flow patterns in the interior cavity 20. FIG. 18A is an isolated side view of the first fitting 70, first valve assembly 90, and second hose whereas FIG. 18B is an exploded view of the first fitting 70, and first valve assembly 90, and the first hose. Once the step of formation is complete, the first valve assembly 90 and the first connector 71 and first hose 92 can be removed, and the first port 28 can be plugged.

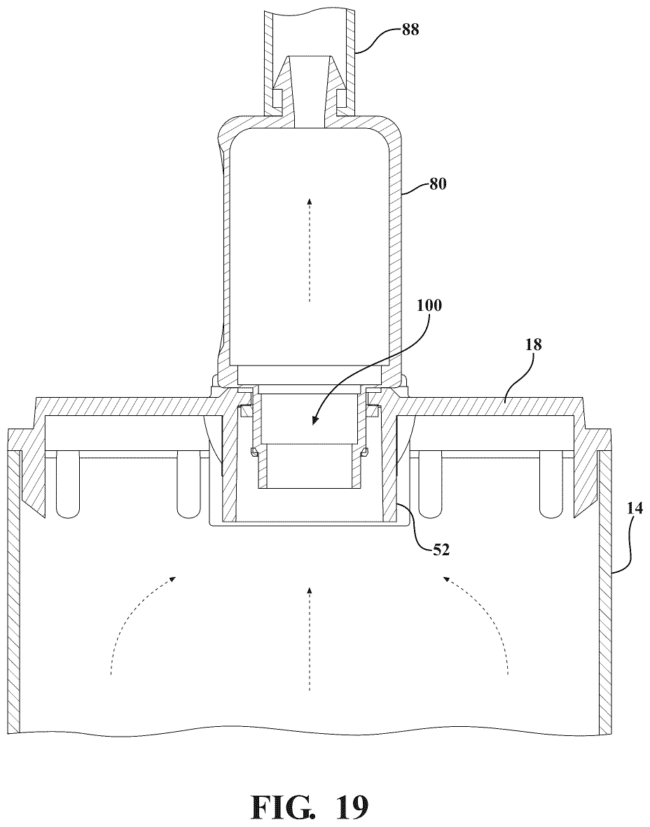

FIG. 19 is a cross-sectional side view of the second port 26 defined by the second collar 52 of the jar cover 18 of the battery assembly 10 at the upper end 46 of the battery assembly 10 of FIG. 17.

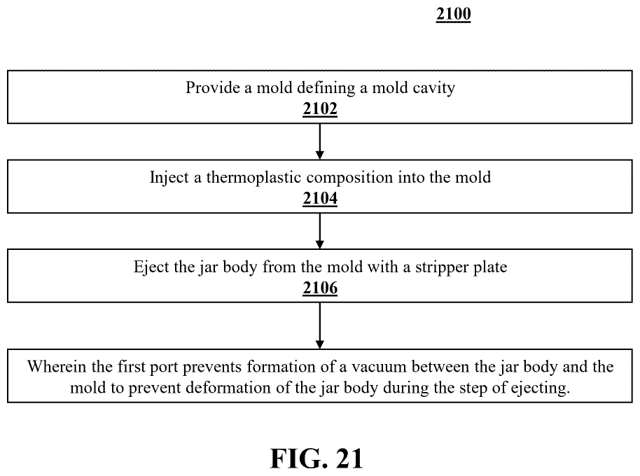

Referring now to FIG. 21, the method of making the battery assembly is disclosed at 2100. As described above, the battery assembly comprises the jar body defining an interior cavity disposed about the vertical axis and having an upper end and the lower end. The jar body includes the floor, the one or more sidewalls, and a recessed wall portion defining a first port adjacent the lower end is also disclosed. The method 2100 includes the steps of:
providing a mold defining a mold cavity (2102);
injecting a thermoplastic composition into the mold (2104); and
ejecting the jar body from the mold with a stripper plate (2106);
   wherein the first port prevents formation of a vacuum between the jar body and the mold to prevent deformation of the jar body during the step of ejecting.

The mold can be a tombstone mold. In some embodiments, the step of injection fluid at least partially overlaps with the step of ejecting. In some embodiments, the method also includes the step of ejecting the battery jar from the mold robotically. In one embodiment, the step of ejecting is conducted with the stripper plate. Advantageously, the first port does double duty, it serves as vacuum breaking opening during the step of ejecting and is later used to provide an access point for the injection of the electrolyte composition to replace evacuated electrolyte composition form the battery jar and speed up formation of the battery cell.

In one embodiment, the method further comprises the step of molding the jar cover shaped for attachment to the upper end of the battery jar. The jar cover comprises the second port, the positive terminal port, and the negative terminal port. As is described above the first and second ports of the battery assembly can be used to evacuate and replace electrolyte composition to create an electrolyte composition flow pattern to expedite formation of a battery cell. In one embodiment, the method further includes the step of insert molding a negative lead post or the negative electrical fitting into the jar cover.

In one embodiment, the method further comprises the step of coupling a positive electrical fitting (sometimes referred to as a positive lead post) in the positive port in the jar cover. The step of coupling can occur with a bayonet type fitting. That is, a bayonet type fitting can be used to secure or seat the positive electrical fitting in the positive port of the cover. Of course, the method can also include the step of coupling the second valve assembly in the second port and inserting a plug in the first port.

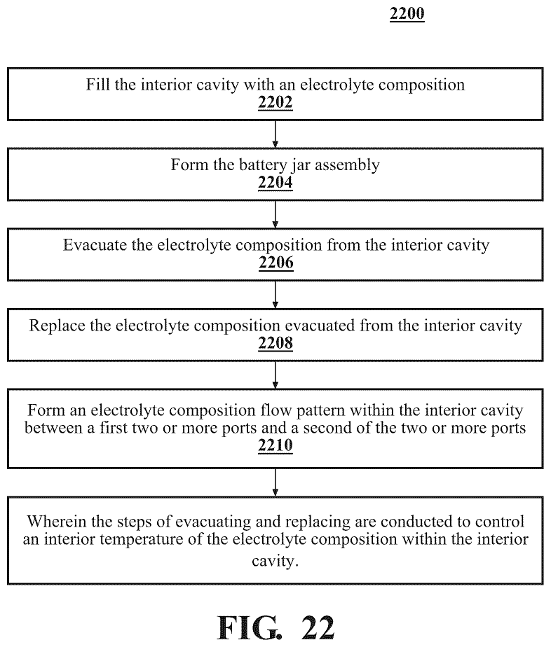

Referring now to FIG. 22, a method of forming a battery is disclosed at 2200. The battery cell includes the battery assembly having the upper and the lower end and comprising the battery jar and the jar cover. The battery jar defines the interior cavity disposed about the vertical axis and also defines the first port. The method (2200) includes the steps of:
filling the interior cavity with an electrolyte composition (2202);
forming or formation of the battery assembly (2204);
evacuating the electrolyte composition from the interior cavity (2206);
replacing of the electrolyte composition evacuated from the interior cavity (2208); and
forming an electrolyte composition flow pattern within the interior cavity between a first two or more ports and a second of the two or more ports (2210).

The steps of evacuating and replacing are conducted to control an interior temperature of the electrolyte composition within the interior cavity as endothermic reactions occur and as the electric charge is applied during formation.

Generally speaking, the method can include many steps including assembly, filling, forming (including pickling and applying current), and final assembly. The forming step, which includes pickling and charging, is critical and time consuming. The battery assembly allows for temperature control during formation thereby reducing forming time and increasing battery quality.

The method includes the step of filling the interior cavity with the electrolyte composition. In some embodiments, the electrolyte composition introduced during filling is at a temperature of from about 0 to about 40, from about 5 to about 30, or from about 5 to about 20° C. Of course, the electrolyte composition introduced during filling can be used to lower or raise the interior temperature. As such, the electrolyte composition introduced during filling can have a temperature of from about 2 to about 20, or from about 5 to about 15° C. different that the interior temperature. The interior cavity has a fill capacity and can be filled with a fill amount up to but not exceeding that capacity during the step of filling. For lead acid batteries, the electrolyte composition is sulfuric acid in water. Some embodiments of the electrolyte composition have a specific gravity range of from about 0.8 to about 1.5, from about 1.0 to about 1.380, or from about 1.1 to about 1.280.

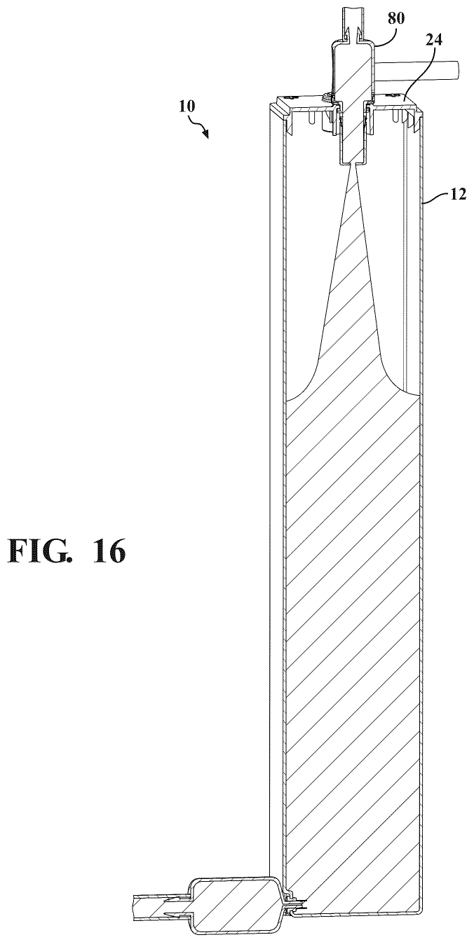

In some embodiments, the step of filling is conducted under a vacuum and the vacuum is pulled before or simultaneous to the filling. FIG. 16 is cross-sectional view of the battery assembly of FIG. 14 illustrating the second valve assembly filling the interior cavity of the battery assembly with the electrolyte composition. FIG. 19 is a cross-sectional side view of the second port defined by the second collar of the jar cover of the battery assembly at the upper end of the battery assembly of FIG. 17 evacuating the electrolyte composition from the interior cavity of the battery assembly.

The method includes the step of forming/formation. During the step of forming, the battery is prepared to receive an electrical charge and then charged or formed. The forming process is critical to the performance and lifespan of a battery. Formation is often the bottleneck in battery production. The process can take up three days. A first part (or pre step or sub step) of formation is “soaking” or “pickling.” During this pre step, before switching on the current for formation of the battery assembly, the cured plates are soaked for a certain period of time in the electrolyte composition. This period is called ‘soaking’ or ‘pickling’. The step of formation occurs after the positive and negative plates have been produced. Formation also involves connecting the battery assembly to a power supply. In the method, the step can be performed with the plates installed in the battery case or prior to their installation. After formation, the battery undergoes final assembly and is ready for shipment.

During the step of forming, a first chemical reaction occurs which prepares the battery assembly to receive an electrical charge. After the lead plates have been finished and prepared, they are immersed—singly or in positive/negative pairs—into a solution of sulfuric acid for several hours. The reaction between the lead plates and the electrolyte composition (e.g. sulfuric acid) causes layers of lead sulfate to form on the plate surfaces. This formation of lead sulfate is critical to the electrochemical reaction that allows the battery assembly to do its job. Managing variables such as acid concentration and soak time can improve the performance of the battery assembly.

In some embodiments, the steps of evacuating and replacing are conducted simultaneously with the step of formation. In some such embodiments, the step of formation includes the sub steps of pickling and/or applying an electric charge. In some embodiments, the interior cavity has a fill capacity and the steps of evacuating and replacing of the electrolyte composition are conducted with a volume of the electrolyte composition that is greater than the fill capacity. In some such embodiments, the steps of evacuating and replacing further include at least partial replacement of the electrolyte composition. For example, the steps of evacuating and replacing can include removal of a first electrolyte composition and replacement with a second electrolyte composition. In one such example, the first electrolyte composition has a lower specific gravity than the second electrolyte composition. In another such example, the first electrolyte composition has a higher specific gravity than the second electrolyte composition. In some embodiments of the method, the specific gravity of the electrolyte composition in the interior cavity is maintained between about 1.05 and 1.25.

The steps of evacuating and replacing are typically completed when reactions during the pickling and formation are completed.

In some embodiments, the electrolyte composition introduced during the step of replacing has a chilled temperature, which is below the interior temperature of the battery assembly and below, at, or above an ambient temperature. For example, the electrolyte composition can have a chilled temperature of from about 0 to about 20° C. Of course, the step of replacing can also introduce the electrolyte composition at an elevated temperature. To this end, during the step of formation (including pickling) the additional electrolyte composition can be introduced at an elevated temperature within the interior cavity and is heated to a temperature above ambient temperature. The steps of evacuating and replacing are often conducted simultaneously with the step of pickling and/or formation.

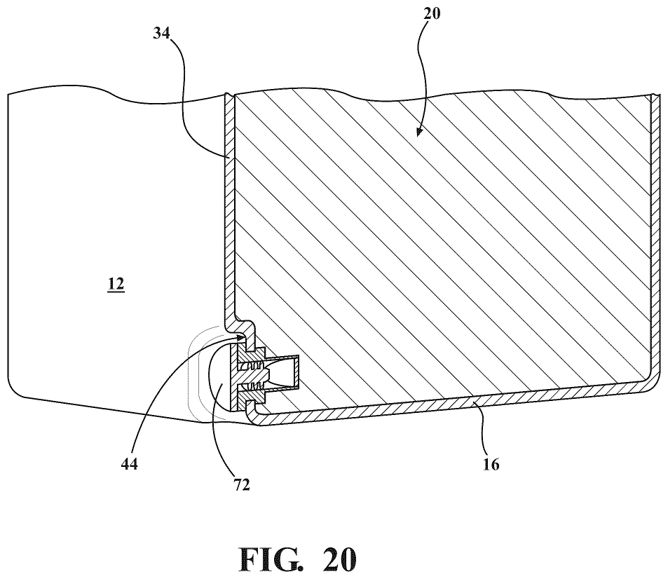

In some embodiments, a second of the one or more ports is located proximal the upper end of the battery assembly and the step of evacuating occurs through the second of the one or more of the valve assemblies located in the second port. In some such embodiments, a first of the one or more ports is located proximal the lower end of the battery assembly and the step of replacing occurs through the first of the one or more valve assemblies located in the first port 28. FIG. 19 is cross-sectional view of the battery assembly 10 with the arrows illustrating the evacuation of the electrolyte composition through the second port and FIG. 18 is cross-sectional view of the battery assembly 10 illustrating the first valve assembly 90 disposed in the first port with the arrows representing flow of the electrolyte composition to replace the electrolyte composition evacuated from the interior cavity. Referring back to FIG. 17, the arrow represents flow of the electrolyte composition from the lower end of the internal cavity to the upper end of the internal cavity. Once the step of formation is complete, the first valve assembly 90 and the first hose 92 can be removed, and the first port 28 can be plugged. FIG. 20 is cross-sectional view of a battery cell comprising the battery assembly having the plug 72 disposed in the first port 28.

In some embodiments, the steps of evacuating and replacing create a flow pattern within the interior cavity in an upward direction along the vertical axis. In some embodiments, the steps of evacuating and replacing create a flow pattern within the interior cavity in a downward direction along the vertical axis. In some embodiments, the steps of evacuating and replacing create a flow pattern across the interior cavity in a direction perpendicular to the vertical axis. In some embodiments, the step of replacing can be conducted through two or more input ports. Likewise, in some embodiments, the step of evacuating is conducted through two or more output ports.

Some embodiments of the method further comprise the step of introducing one or more additional fluids into the interior cavity. In some such embodiments, the one or more additional fluids flowing through the battery assembly raise the interior temperature of the battery assembly to cure one or more active materials. In many such embodiments, the one or more fluids which circulate through the battery assembly include electrolyte, air, one or more drying fluids, one or more lead collection fluids, one or more reactive materials, one or more electrolyte removal fluids, or a combination thereof. In some embodiments, the one or more additional fluids are partially segregated while flowing within the interior cavity of the battery assembly simultaneously. The one or more additional fluids can also heat and/or cool different portions of the battery assembly independently. In some examples, the one or more additional fluids heat and/or cool the different portions simultaneously.

In some embodiments, the method includes plugging the one or more ports after forming is complete. A plug can be received in the one or more ports to seal the interior cavity temporarily or permanently from an exterior of the battery assembly.

The one or more additional fluids can include air having a humidity level of from about 50 to about 100%. The one or more additional fluids can include one or more drying fluids, e.g. drying gasses, such as water sequestering liquids, critical point drying fluids, or a combination thereof. The one or more additional fluids flowing through the battery assembly can dry one or more active materials, fluids, or a combination thereof.

The one or more additional fluids flowing through the battery assembly can include one or more lead collection fluids such as lead sulfate. The one or more additional fluids can include one or more electrolyte removal fluids, and wherein the one or more electrolyte removal fluids are configured to displace and remove electrolyte from the interior cavity of the battery assembly. If used, the one or more electrolyte removal fluids include acetic acid, methane sulfonic acid, or both.

The one or more additional fluids can include one or more reactive materials. If used the one or more reactive materials include one or more oxidizing agents, passivating agents, solvating agents, or a combination thereof. For example, hydrogen peroxide, methane sulfonic acid, phosphoric acid, lead ions in solution, sodium sulfate, organo-lingo sulfonates, or a combination thereof.

The one or more oxidizing agents can reduce free lead in an unformed paste of one or more active materials. The one or more passivating agents reduce, prevent, or stop lead corrosion in electrochemical cells after forming. The one or more additional fluids include hydrogen, oxygen, or both.

In one embodiment, a first of the one or more ports is located proximal the lower end of the battery assembly and the step of replacing occurs through a first fitting 70 including a first valve seated in the first ports, and a second of the one or more ports is located proximal the upper end of the battery assembly. In this embodiment, the step of evacuating occurs through a second of the one or more of the valve assemblies seated in the second port. As such, the steps of evacuating and replacing create an electrolyte composition flow pattern within the interior cavity with the electrolyte composition moving from the lower end of battery jar to the upper end of the battery jar in upward direction along the vertical axis.

In one embodiment, the method includes the step of seating a plug in the first port subsequent to the step of formation. FIG. 20 is cross-sectional view of a battery cell comprising the battery assembly having the plug disposed in the first port.

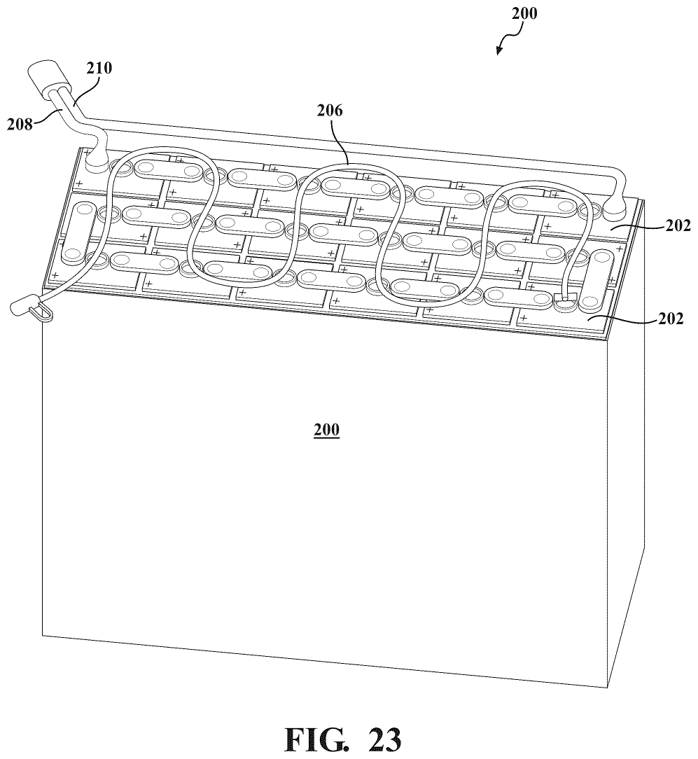

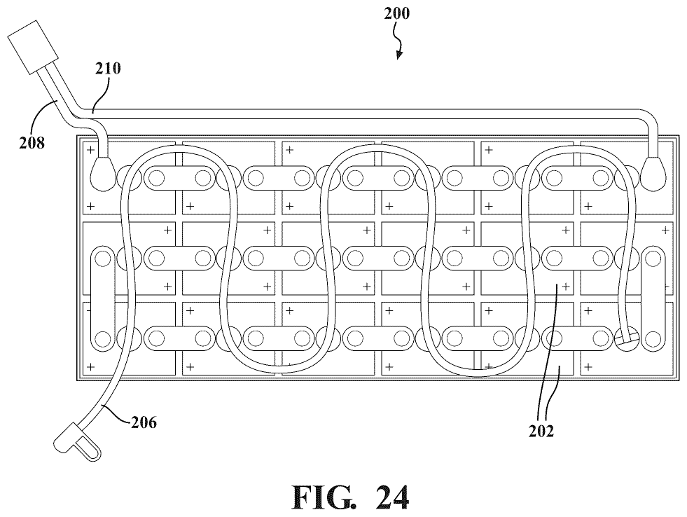

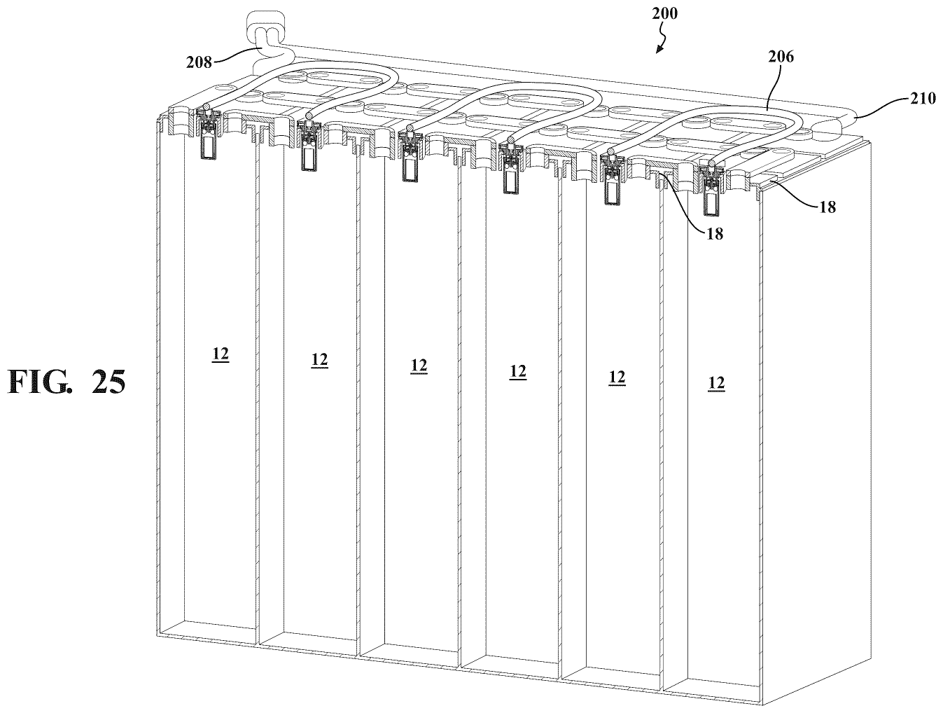

Of course, many embodiments of the method involve forming one or more battery cells simultaneously. FIG. 23 is a perspective view of a battery 200 including a plurality of battery cells 202, each battery cell comprising the battery assembly 10 including the jar body 12 and the jar cover 18. FIG. 24 is a top view of the battery of FIG. 23 including the plurality of battery cells 202 in fluid communication with a fluid source via a fluid line 206 and electrical communication with a positive power line 208 and a negative power line 210. FIG. 25 is a cross-sectional view of the battery of FIG. 23 at 25-25 including a plurality of battery cells in fluid communication with a fluid source and electronic communication with a power source.

The above description is that of current examples of the disclosure. Various alterations and changes can be made without departing from the spirit and broader aspects of the disclosure as defined in the appended claims, which are to be interpreted in accordance with the principles of patent law including the doctrine of equivalents. This disclosure is presented for illustrative purposes and should not be interpreted as an exhaustive description of all examples of the disclosure or to limit the scope of the claims to the specific elements illustrated or described in connection with these examples. For example, and without limitation, any individual element(s) of the described disclosure may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed examples include a plurality of features that are described in concert and that might cooperatively provide a collection of benefits. The present disclosure is not limited to only those examples that include all these features or that provide all the stated benefits, except to the extent otherwise expressly set forth in the issued claims. Any reference to claim elements in the singular, for example, using the articles “a,” “an,” “the” or “said,” is not to be construed as limiting the element to the singular.

1. A battery assembly for circulation of an electrolyte composition comprises:
a jar body having an upper end and a lower end and a jar cover, the jar body comprising a floor, one or more sidewalls presenting an exterior and an interior surface, which defines an interior cavity disposed about a vertical axis;
two or more ports including a first port and a second port; and
one or more valve assemblies;
wherein the electrolyte composition is evacuated from the interior cavity through the first port or the second port and is replaced with additional electrolyte composition through the other port to create an electrolyte composition flow pattern between the lower end and the upper end of the jar body.

2. The battery assembly of claim 1, wherein the first port is defined by a first sidewall of the one or more sidewalls and proximal the lower end of the jar body.

3. The battery assembly of claim 2, wherein the first port is defined by a recessed wall portion of the jar body.

4. The battery assembly of claim 3, wherein a first end of a first fitting disposed in the first port does not break a plane defined by an exterior surface of the first sidewall.

5. The battery assembly of claim 3, wherein the recessed wall portion comprises a recessed floor and a horseshoe shaped wall.

6. The battery assembly of claim 5, wherein the recessed wall portion defines a cutout in the floor 16 opposite a curved portion of the horseshoe shaped wall.

7. The battery assembly of claim 6, wherein a first valve assembly is disposed at a second end of the first fitting.

8. The battery assembly of claim 7, wherein the first valve assembly is further defined as a one-way valve.

9. The battery assembly of claim 1, wherein the floor includes a plurality of bridge rests extending into the interior cavity for supporting a plurality of battery plates.

10. The battery assembly of claim 9, wherein the plurality of bridge rests create a gap between an upper surface of the floor and the plurality of battery plates.

11. The battery assembly of claim 10, wherein:
a second end of a first fitting,
a second end of a first valve assembly, and/or
a hose extending from the second end of the first fitting, or the first valve assembly extends into the gap.

12. The battery assembly of claim 1 wherein:
the second port is defined by the jar cover and is shaped to receive:
a first connector for evacuation of the electrolyte composition during formation; and
a second valve assembly for filling the interior cavity with the electrolyte composition.

13. The battery assembly of claim 1, wherein:
the first port is for replacing evacuated electrolyte composition and is defined by the one or more sidewalls proximal the lower end of the jar body; and
the second port is for evacuating the electrolyte composition and is defined by the jar cover proximal the upper end of the jar body,
wherein when the electrolyte composition is evacuated and replaced with additional electrolyte composition to create the electrolyte composition flow pattern with the electrolyte composition moving from the lower end of the jar body to the upper end of the jar body in upward direction along the vertical axis.

14. The battery assembly of claim 1, wherein at least one of the two or more ports are shaped to receive a plug.

15. A method of making a battery assembly comprising a jar body defining an interior cavity disposed about a vertical axis and having an upper end and a lower end, the jar body including a floor, one or more sidewalls, and a recessed wall portion defining a first port adjacent the lower end, said method comprising the steps of:
providing a mold defining a mold cavity;
injecting a thermoplastic composition into the mold; and
ejecting the jar body from the mold with a stripper plate;
wherein the first port prevents formation of a vacuum between the jar body and the mold to prevent deformation of the jar body during the step of ejecting.

16. The method of claim 15, further comprising the step of molding a jar cover shaped for attachment to the upper end of the jar body, the jar cover comprising a second port, a positive terminal port, and a negative terminal port, wherein the first and second ports can be used to evacuate and replace electrolyte composition to create an electrolyte composition flow pattern to expedite formation of a battery cell.

17. A method of forming a battery including a battery assembly including a battery jar defining an interior cavity disposed about a vertical axis and having an upper and a lower end and a jar cover, the battery assembly defining two or more ports, said method comprising the steps of:
filling the interior cavity with an electrolyte composition;
forming the battery assembly;
evacuating the electrolyte composition from the interior cavity;
replacing of the electrolyte composition evacuated from the interior cavity; and
forming an electrolyte composition flow pattern within the interior cavity between a first two or more ports and a second of the two or more ports;
wherein the steps of evacuating and replacing are conducted to control an interior temperature of the electrolyte composition within the interior cavity.

18. The method of claim 17, wherein:
a first of the one or more ports is located proximal the lower end of the battery assembly and the step of replacing occurs through a first fitting including a first valve seated in the first port; and
a second of the one or more ports is located proximal the upper end of the battery assembly and the step of evacuating occurs through the second port;
wherein the steps of evacuating and replacing create an electrolyte composition flow pattern within the interior cavity with the electrolyte composition moving from the lower end of battery jar to the upper end of the battery jar in an upward direction along the vertical axis.

19. The method of claim 18, wherein the interior cavity has a fill capacity and the steps of evacuating and replacing are:
conducted with a volume of the electrolyte composition that is greater than the fill capacity; and/or
include at least partial replacement of the electrolyte composition.

20. The method of claim 18 further comprising the step of seating a plug in the first port subsequent to the step of formation and/or seating a second valve assembly in the second port subsequent to the step of formation.
